(19) United States
(12) Patent Application Publication
(10) Pub. No.: US 2011/0246518 A1
(43) Pub. Date: Oct. 6, 2011

(54) METHOD AND SYSTEM OF DISTRIBUTED CACHING

(75) Inventors: Prateek Mehrotra, Uttar Pradesh (IN); Kannan R. Venugopal, Theni District (IN); Vishal Bhasin, Haryana (IN); Sumit K. Mukherjee, Tamil Nadu (IN); Santosh Arroju, Hyderabad (IN)

(73) Assignee: VERIZON PATENT AND LICENSING INC., Basking Ridge, NJ (US)

(21) Appl. No.: 12/752,616

(22) Filed: Apr. 1, 2010

(51) Int. Cl. G06F 17/30

(52) U.S. Cl. 707/770; 707/E17.032

(57) ABSTRACT

An approach is provided enabling efficient access to and storage of data within a database system comprising a plurality of data repository sites distributed across different physical locations. A processor receives a request for data, the request specifying a key value. The processor determines a bucket associated with one of a plurality of data repository sites of a virtual cache based on the key value, the data repository sites being in different physical locations. The association between the bucket and the one data repository site is based on probability of serving the request.

### BACKGROUND INFORMATION

Information systems continue to form an integral part of any business or organization. With geographical distances no longer a concern in the modern era, information is today stored at multiple locations miles apart. This information is accessed several times during the course of interaction between a user and the business' computing systems. Due to varying requirements and behavioral patterns, each system fetches certain pieces of relevant information from different backend systems. Backend refers to the data repositories that are accessible either directly through database or indirectly through other services. Typically, an interaction is spread across systems, which in turn, might fetch one or more subsets of information from the same set of backends. This increases redundant load on the corresponding systems, this load increasing exponentially as the number of interactions increases. There is a need to, therefore, identify key sets of information that are frequently used and store them at an easily accessible location for future retrieval, thereby reducing the workload on the backend systems.

### BRIEF DESCRIPTION OF THE DRAWINGS

The embodiments of the invention are illustrated by way of example, and not by way of limitation, in the figures of the accompanying drawings:

FIG. 1 is a diagram of a distributed virtual caching system comprising a plurality of data repository sites for enabling data storage or data retrieval requests;

FIG. 2 is a flowchart depicting a process for retrieving data from the distributed virtual cache system, according to one embodiment;

FIG. 3 is a flowchart depicting a cache expiry process of the distributed virtual caching system, according to one embodiment;

FIG. 4 is a flowchart depicting a data retrieval request handling process of the distributed virtual caching system utilizing a client-server architecture, according to one embodiment;

FIG. 5 is a flowchart depicting the data storage request handling process of the distributed virtual caching system, according to one embodiment;

FIG. 6 is a flowchart depicting a process for accessing the distributed virtual caching system in connection with an interactive voice response system, according to one embodiment;

FIG. 7 illustrates a computer system 700 upon which an embodiment of the invention may be implemented; and

FIG. 8 illustrates a chip set 800 upon which an embodiment of the invention may be implemented.

### DESCRIPTION OF THE PREFERRED EMBODIMENT

Examples of a method, apparatus and system for a implementing a distributed virtual cache system is disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various exemplary embodiments are described with respect to a virtual caching system utilized within a client-server architecture, it is contemplated that various exemplary embodiments are applicable to other or equivalent caching systems and architectures. Further, it is contemplated that the caching system can be integrated with other database systems.

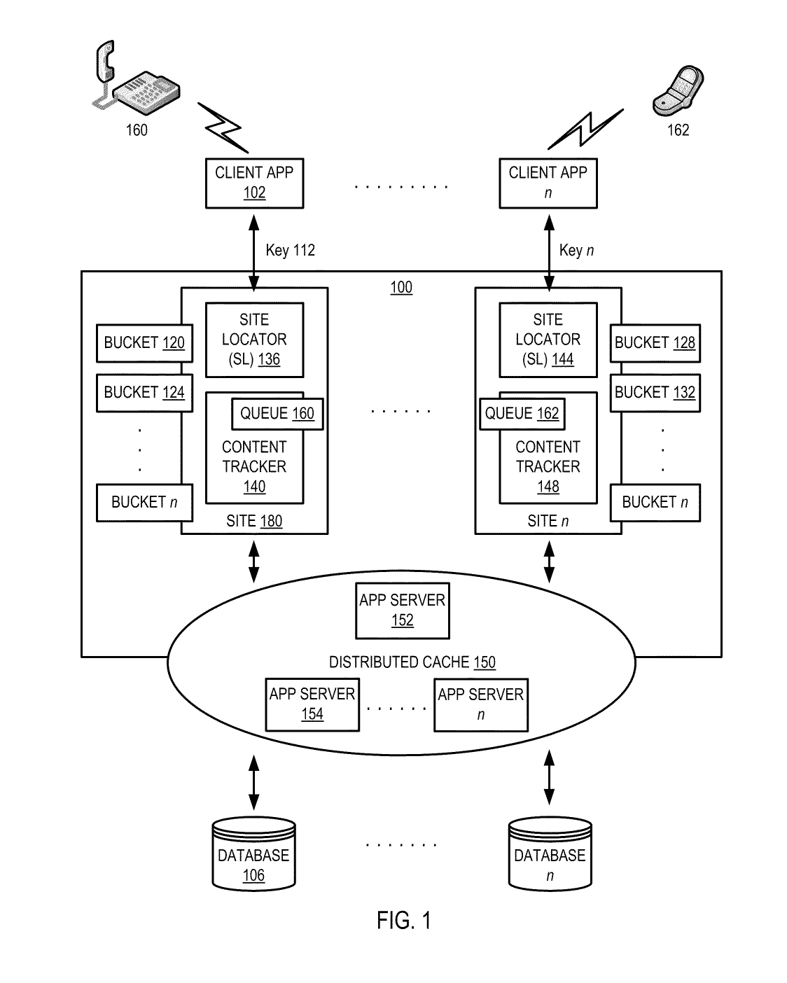

FIG. 1 is a diagram of a distributed virtual caching system comprising a plurality of data repository sites for enabling data storage or data retrieval requests. For illustrative purposes, system 100 provides a caching system using a client-server architecture to implement a virtual distributed cache. A cache permits quick access and retrieval of data vis-à-vis a traditional database system. For example, the cache can be store non-persistent data in random access memory (RAM) to enable more rapid data transactions, according to one embodiment. As a cache system, system 100 does not permanently store data, as in a database system; however, it is contemplated that, depending, on the application (e.g., in which more persistent data is needed), system 100 can be implemented in conjunction with a database system. In certain embodiments, the term virtual refers to the fact that applications can view the caching system as a uniform and large. When specific data sets are commonly and recurrently called upon from the same limited set of data repositories within the caching system, latencies can abound, which in turn adversely impact the ability of the application (e.g., interactive voice response (IVR) systems) requesting processing of data to fulfill a transaction.

Many information, telecommunications or computing networks requiring on demand retrieval or storage of mission critical data in order to fulfill customer transactions, application service requests and other business needs. Systems that fall into these categories may include, but are not limited to, interactive voice response systems (IVRs), intelligent switchboard configurations, automated outbound/inbound calling solutions, telephony applications, computer aided communication systems and any other person-to-computer based interaction platforms and applications. All of these systems require quick, reliable access to transactional data, generally maintained in a database or backend system.

To address these problems, a caching system implemented as a virtual cache is provided, whereby the virtual cache is regionalized (e.g., by geographic region).

As shown, distributed virtual caching system 100 includes one or more data repository sites 150 for enabling data storage or retrieval with high efficiency. Specifically, the virtual caching system 100 interacts with one or more applications 102-104, which may be client applications capable of requesting retrieval or storage of data accordingly from the various data repositories 150. According to certain embodiments, data repositories are implemented, at least in part, as distributed cache 150—i.e., an interconnected network of virtual, temporary or interim storage mediums for holding recently or recurrently accessed data (e.g., local copy) necessary for application processing. In general, a cache is designed to speed up subsequent access to recurring data as an alternative to persistently accessing a main data store. In one embodiment, the distributed cache 150 can be geographically dispersed. Thus, different physical locations wherein the distributed cache 150 resides may be more suitable for access by the one or more client applications 102-n than others.

In the example of FIG. 1, the client applications 102-n requiring access to distributed cache 150 are IVRs for automating a communicative interaction with a caller over a touch-tone phone 160 or 162. IVR systems, among other features, provide the ability to play and record prompts and gather touch-tone input as provided by the caller. An IVR platform may also recognize spoken input from callers (voice recognition), translate text into spoken output for callers (text-to-speech) and transfer IVR managed calls to a telephone or call center agent. Hence, client applications 102-n are computer-executable programs that control and respond to calls via the IVR platform/system. These applications call on various application servers 1-n to retrieve records and/or store information as required during the course of a call. In certain embodiments, databases 106-n can be deployed to interoperate with the distributed cache 150 to house permanent data (depending on the application). Database systems,” as used herein, refer to any configuration of data storage repositories that are interconnected and accessible directly through database storage, warehousing and mining techniques or indirectly through other retrieval/storage means.

It is noted that businesses (or organizations) employ interactive voice response systems (IVRs) in conjunction with distributed databases to enable callers to readily interact with and access certain data directly from a touch-tone telephone. The data repositories that house pertinent caller data can be accessed either directly through known data warehousing techniques or indirectly through other services, such as the IVR. For example, banks and credit card companies use IVR systems so that customers can receive up-to-date account information instantly from a data repository without having to speak directly to a person—i.e., a call center or customer service representative. The system may also be configured to allow the caller to update or store information as well. Because IVR technology does not require human interaction, the caller's ability to retrieve or store data is controlled by the IVR, with user interaction with the system being executed through the touch-tone keypad or by voice recognition technology.

Due to varying requirements and system configurations, different IVR systems fetch data from, or store information to the distributed caching systems to which they are connected in different ways. Quite often, the various data repositories comprising a company's overall information system are geographically dispersed. Hence, it is not uncommon for a caller's data to be spread across different repositories. Initial IVR processing of an incoming call may require the accessing of the information from a first data repository, which in turn, upon subsequent IVR processing or call transfer, requires the fetching of one or more subsets of information from the very same repository. This increases the redundant load on the corresponding data repositories and the database system as a whole; a load that increases exponentially as the number of caller interactions with the company's IVR increases.

To facilitate, manage and control data retrieval, data storage and better balance overall workload capacity according to certain embodiments, the virtual cache 100 is further implemented to identify buckets. Buckets 120, 124 through n for Site 180 and 128, 132 though n for Site n are a class of objects or abstract data representations for organizing client application requests having similar characteristics. It will be seen in later paragraphs that the identification and categorization of received request types on the basis of buckets is carried out by a site locator (SL) module in conjunction with a content tracker (CT) as more fully described below.

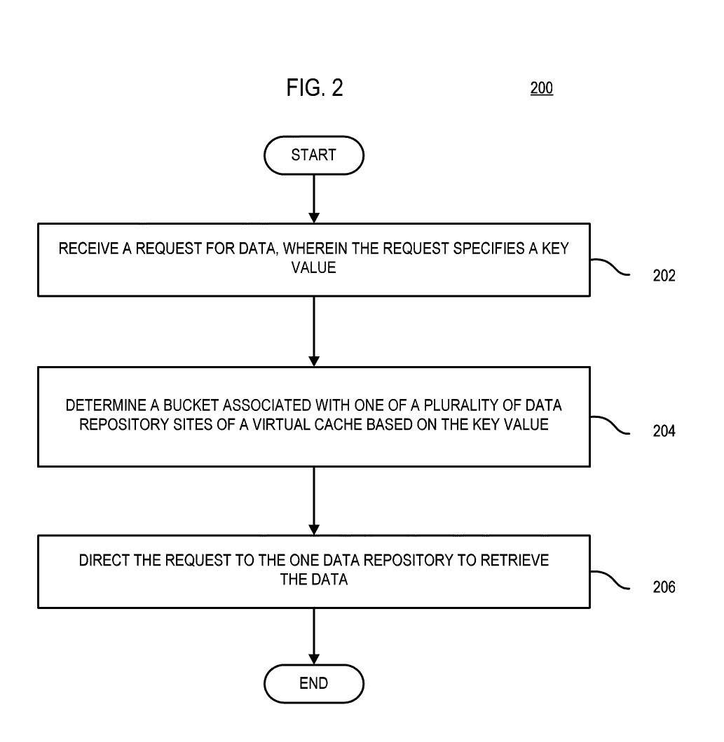

FIG. 2 is a flowchart depicting a process 200 for retrieving data from the distributed virtual cache system, according to one embodiment. In FIG. 2, a first step for retrieving data from the distributed virtual cache system 100 is to receive a request for data, wherein the request specifies a key value (Step 202). The key 112 is an identifier used to store or retrieve information from the virtual cache system, and can be parameter value that is relevant to the core functionality or identity of an information system (e.g., the IVR). The virtual cache system 100 then determines a bucket associated with one of a plurality of data repository sites of the virtual cache 100 based on the key value. In one embodiment, the data repository sites 150 are situated in different physical locations. Moreover, the association between the bucket and the one data repository site is, according to one embodiment, based on probability of serving the request (Step 204). As stated above, the repositories of the virtual cache 100 are distributed cache over a host of geographically distanced sites. Depending on system and implementation preferences, each cache may be further implemented as a “cloud” containing the cluster of application servers 1-n. A cloud, as presented herein, refers to any means for sharing computing resources (as opposed to local resources) and enabling the delivery of hosted services over, e.g., the Internet, such as to accomplish a desired task—i.e., employing a particular infrastructure, platform or software utility as web-executable service. As a final step, the virtual cache system 100 directs the request to the one data repository to retrieve the data (Step 206).

With reference again to FIG. 1, the consideration for grouping received client applications 102-104 requests into buckets, depicted in the diagram as Bucket 120, 124 to Bucket n or 128, 132 to Bucket n for Site 180 and n respectively, is established by the individual client applications 102-n. Hence, the client applications are programmatically implemented to account for specific logical organizational schemes in which they call for/request data from a given database. Keys 112 are passed along to the virtual cache by the client applications 102-n to validate or permit the calling application to store and/or retrieve content from the database; in this case data required for enabling the caller to interact with an IVR. Cache implementations operate, for example, on the concept of a key-value pair, wherein the key is a unique identifier and a value that is the actual data for the key, although other implementations are within the scope of the example. The virtual cache 100, upon receipt of a key 112-n, groups them into buckets based on pre-established categorization criteria associated with that particular key (e.g., request type, data and time, user type, location type, timing, transaction type, IVR escalation/service code etc.). Data representative of such criteria may be bundled with the request as a tag or metadata.

Upon receipt, the keys are in turn mapped to one of many potential geographical sites 180-n, each site representing a physical location of distributed cache 150. One major factor in deciding the relationship between a bucket and a specific site 180-n is the probability of serving ‘local’ requests from that site. A local request refers to one received from a client physically located at the closest available geographic proximity to a given virtual cache site 180-n. Closer proximity to the point of request origination results in reduced distances, which further translates to reduced latencies (assuming all other factors remain constant). Hence, the higher the probability of a local request, the greater the chances of mapping a bucket to that site. Of course, other probability factors may be considered as well, including current site workload capacity of the various sites, network operation status of a given site versus another, etc. The scope of the invention is not limited by any one particular probabilistic approach.

According to one embodiment, as a fully scalable, multi-site distributed data implementation, the virtual cache 100 also supports multiple clients simultaneously. This capability can be important in systems such as IVRs, as multiple callers may need to interact with the system at any given time. For this reason, the virtual cache 100 requires the inclusion of a client identifier—a mutually agreed to string sequence that acts as an authenticator—as part of the store and retrieve requests. This ensures data is not accessed by unauthorized systems and also allows the same key to be used hassle free by different clients simultaneously. For example, in the telecommunications industry, the prime identifier to an account is the Telephone Number (TN), while in the banking industry it may be an account number. Again, this data may be associated with or in certain instances accepted as part of the key (e.g., key value pair) or included in with the key by way of tag or metadata.

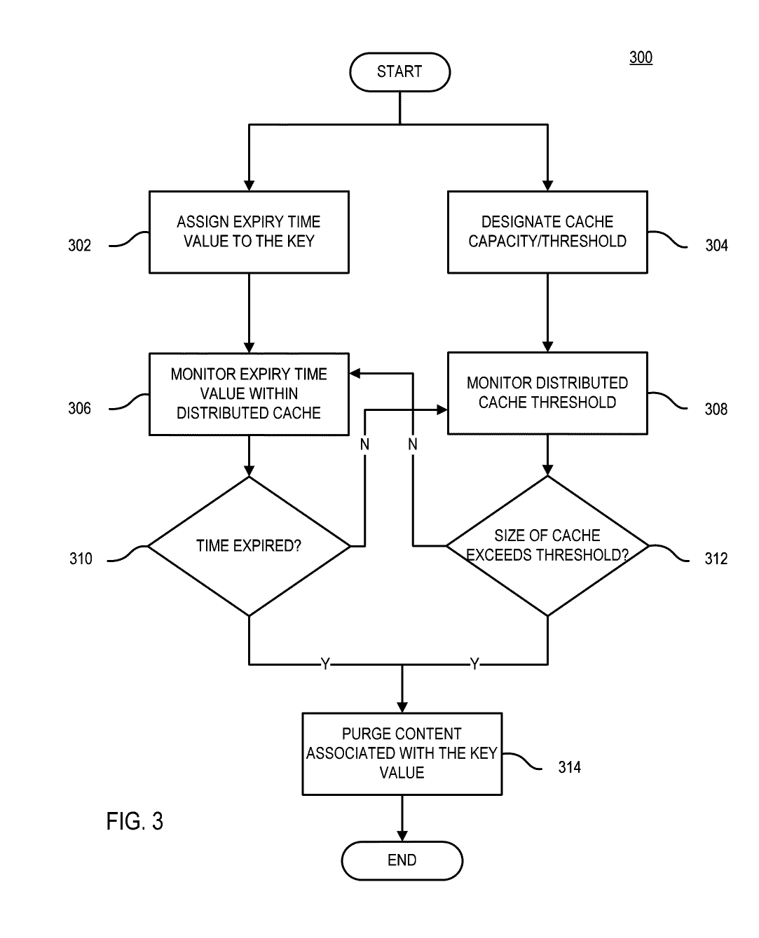

To process incoming data requests, in some embodiments, each site 180-n within the virtual cache 100 is further comprised of a Site Locator (SL) 136, 144 and a Content Tracker 140, 148 respectively. According to one embodiment, the site locators 136 and 144 are the entry point to the client application 102-n, with every store and retrieve request passing through this layer. The SL 136, 144 is an executable module that validates the incoming/passed key (and any other passed data associated with the request) and makes a determination, based on criteria, of which bucket it maps to. Operating in connection with the SL 136, 144, the content tracker has, in certain embodiments, two functions: to load balance the application servers 1, 2 and/or n within a given site 180-n, and to maintain its respective content queue (CQ) 160, 162. The content tracker 140, 148 load balances the application servers that are present within that site 180-n and determines where to cache content to ensure optimal distribution. The content queue 160, 162 contains the list of keys 112-n that have been cached within a particular site 180-n, along with the identity of the client application 102-n associated with the data request, the specific data repository of distributed cache 150 where the desired contents have been cached and their expiry times. According to one embodiment, the CQ 160, 162 is updated when a data store request is handled successfully, or when the cached object expires. According to one embodiment, the expiry process of the distributed virtual caching system is presented with respect to FIG. 3, according to one embodiment.

FIG. 3 is a flowchart depicting a cache expiry process 300 of the distributed virtual caching system, according to one embodiment. The virtual cache system 100, in an effort to maintain maximum efficiency of request processing and workload balancing, ensures the proper release or purge of outmoded cached data. Specifically, the system operates using a combination of time based and capacity based cache expiry mechanisms. Each key in the virtual cache system 100, on creation or update, is assigned an expiry time, corresponding to step 302. The expiry time is a time value or period (interval) after which an entity, data set or object ceases to exist. Furthermore, the virtual cache system is assigned a specific maximum cache capacity/threshold, corresponding to step 304. This threshold may be designated as the summation of individual site established thresholds for distributed cache 150, or assigned as an overall setting regardless of individual site settings. Excess of this threshold also results in cessation of the object or data in question.

In the time based expiry example, the object is purged based on the Time-To-Live (TTL) duration. This TTL is configurable and can be set based on the requirements of the client applications 102-n wanting to make use of the virtual cache system 100. As shown in steps 306 and 310, objects in the virtual cache system 100 are persistently monitored by the CQ or upon successful data request handling to determine if it has reached its expiry time. Concurrently, processing steps 308 and 312 are performed, wherein the virtual cache system 100 is persistently monitored to determine if it has exceeded its threshold. As such, when the time expires or the size exceeds the threshold, whichever happens earlier, the content associated with that key value is purged from distributed cache 150. This corresponds to step 314. It is contemplated that the time expiry threshold and the cache capacity threshold may be used individually or in combination (as describe).

In the scenario where the capacity threshold is determined to be breached first, the Least Recently Used (LRU) algorithm comes into play. The LRU scheme results in the purging of entries with the earliest expiry times first, until the size of the virtual cache system 100 is once again below the capacity threshold. It is recognized that various other processing schemes may be employed in connection with the examples herein to ensure proper cache expiry. Indeed, the example is not limited to any particular implementation.

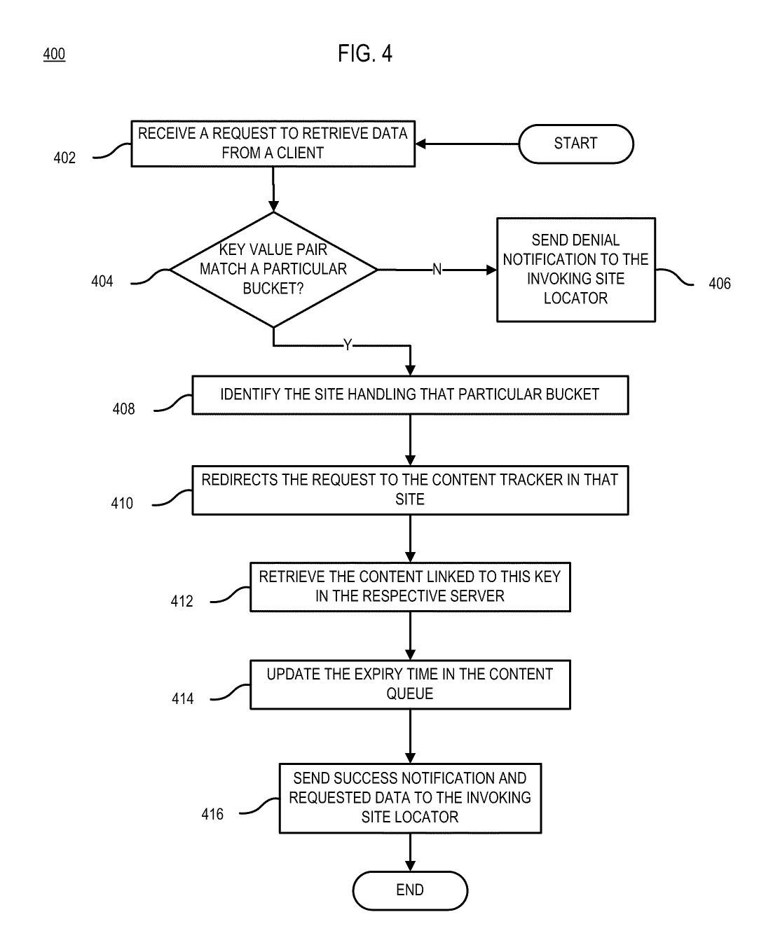

FIG. 4 is a flowchart depicting a data retrieval request handling process 400 of the distributed virtual caching system utilizing a client-server architecture, according to one embodiment. It is contemplated, however, that the process could be implemented using various other interactive architectures as well, including but not limited to cloud computing based, grid computing based, autonomic computing based, utility computing based. In particular, this flowchart presents a more detailed explanation of the retrieval request process 200 presented at a high-level in FIG. 2.

A first step 402 in the process involves receiving a request to retrieve data from a client application (client), the request including a key as discussed before. This request is received by the SL of the distributed virtual caching system 100. As a next step 404, a check is performed to determine if the key matches a particular bucket. If a legitimate bucket associated with the key is not found, a denial notification/error response is returned to the invoking site locator (SL). Subsequently, the denial notification is sent to the requesting client application, as indicated in step 406.

If there is a bucket in which the key can be classified, as presented in steps 408-410, the SL then identifies which geographical site of the virtual cache system 100 handles requests for that bucket and forwards the request to the content tracker for that site. Upon receipt, the content tracker executes a lookup in the content queue (CQ) for the received key and retrieves the contents from the application server 1-n and/or corresponding database 106-n mapped to that key, corresponding to step 412. Having successfully retrieved the data, in steps 414-416 the CQ updates the expiry time, then notifies the SL of successful retrieval and returns the retrieved data to the SL. Finally, the SL provides the success notification and retrieved data to the requesting client application. From the perspective of an IVR, the requesting client application may further interact with caller by leveraging the received data (e.g., share with the user their account balance, payment due date, expected court date, delivery date, survey responses previously provided, etc.).

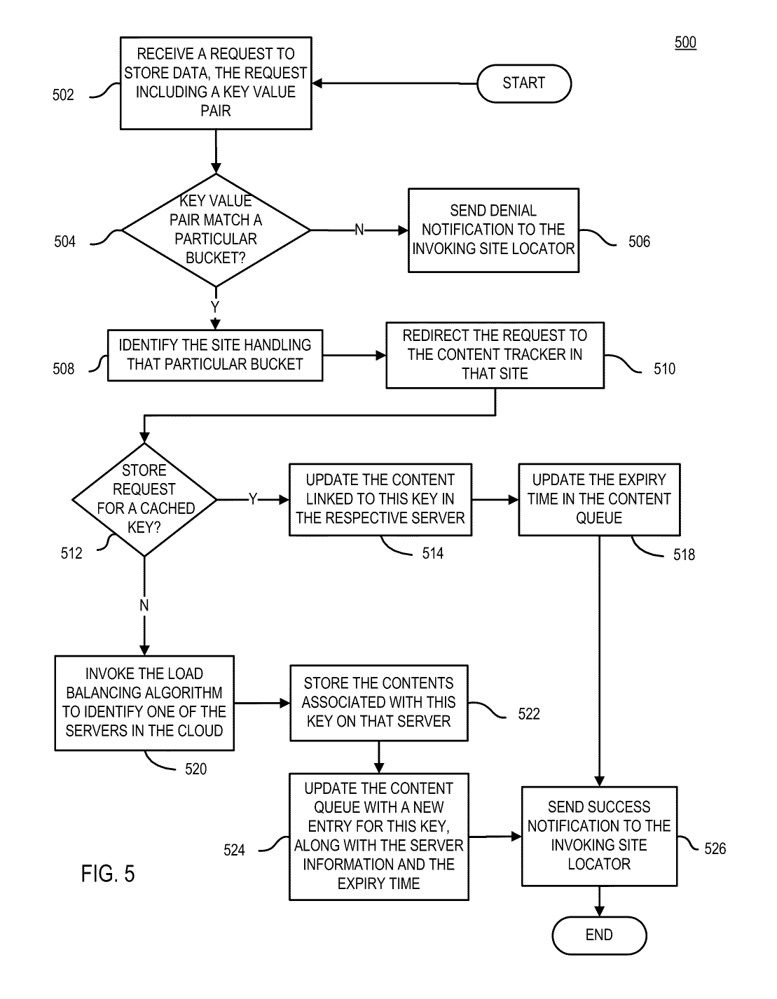

FIG. 5 is a flowchart depicting the data storage request handling process 500 of the distributed virtual caching system, according to one embodiment. Steps 502-510 are similar to steps 402-408 of the data retrieval request handling process presented in FIG. 4. In step 502, the client application makes a data storage request, which it sends along with the appropriate key to the geographically nearest virtual cache system site locator (SL), e.g., SL 136. SL 136 then tries to classify the key into a bucket, and upon a successful match, identifies the site handling that particular bucket and redirects the request to the content tracker in that site. For a data store request, however, there are two scenarios that the content tracker must account for, as presented below: a) the data storage request is for a cached key, or b) the data storage request is for an un-cached key. This is accounted for at step 512.

In the first scenario, when the request is determined to correspond to a cached key, the content tracker updates the contents linked to this key in the respective server. The expiry time in the content queue is also updated accordingly, as presented in FIG. 3. The preceding execution corresponds to steps 514-516.

For the second scenario, when the content tracker is determined to correspond to an un-cached key, the content tracker invokes a load balancing algorithm to determine how and where the data will be stored within distributed cache 150, corresponding to steps 518. Once identified, the content queue stores the contents associated with this key on the identified application server 1-n and/or database 106-n corresponding to the client application request. CQ 160 is then updated with the new entry for this key, and the server information and the expiry time are updated. The preceding execution corresponds to steps 520-522.

In both cases, once the content queue is updated, a success notification is sent to the invoking SL, which then forwards it to the requesting client, corresponding to step 524. Any error encountered anywhere in the entire store process results in an error/denial/failure response notification being returned to the requesting client.

As mentioned before, an IVR is one type of system that may benefit from application of the exemplary techniques presented herein.

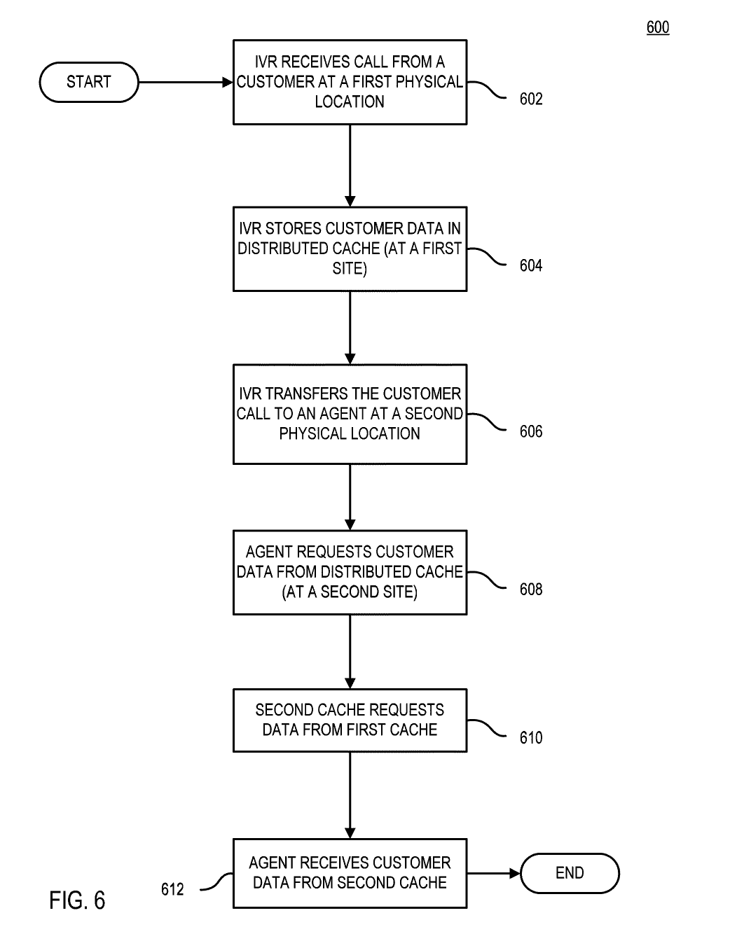

FIG. 6 is a flowchart depicting a process for accessing the distributed virtual caching system 100 described above in connection with an interactive voice response (IVR) system, according to one embodiment. However, the examples as presented are not limited to an IVR application. Indeed, any person-to-computer based communication platforms or applications may apply. Furthermore, the techniques are suitable for accommodating IVRs that may employ various modes of interaction aside from the more commonly used touch-tone or voice based schemes, including video based, text based, interactive touch based, etc.

In step 602, the IVR responds to a call from a customer (or caller). The IVR is at a first physical location, which itself, may be a different physical location than that of the caller as well. As in step 604, the IVR stores customer data it collected via touch-tone pulse sensing, voice recognition or other interaction processing mediums to distributed cache 150 for a first site. As another step 606, the IVR transfers the caller to an agent located at a second physical location. Specifically, the second location corresponds to a different location than the first location of the receiving IVR. The agent, to whom the call has been transferred, now requires access to information regarding the caller. Hence, as yet another step 608, the agent client application requests data regarding the caller, the caller's prior interaction with the IVR or any other data required to fulfill the caller's desired transaction. In accord with the exemplary solutions discussed earlier, however, the agent client application seeks the customer data from distributed cache 150, perhaps even at a second site, as indicated in step 610.

In this example, the data stored in distributed cache at the first site (step 604) can be replicated for quick, easy access at the second distributed cache site. Alternatively, the second distributed cache 150 located at the second site can request the data cached at the first site. The exemplary techniques described throughout contemplate usage of auto-replication techniques or request based techniques. Furthermore, with load balancing techniques applied by the virtual cache system 100 as stated previously, the agent application request may be fulfilled faster through engagement of data repositories that are physically closer and faster. As a final step 612, the agent receives the data for the caller by accessing the second cache; a clear alternative to accessing the company's backend or primary storage systems 106-n, which may include one or more databases.

The processes described herein for enabling effective, balanced data storage and/or retrieval may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

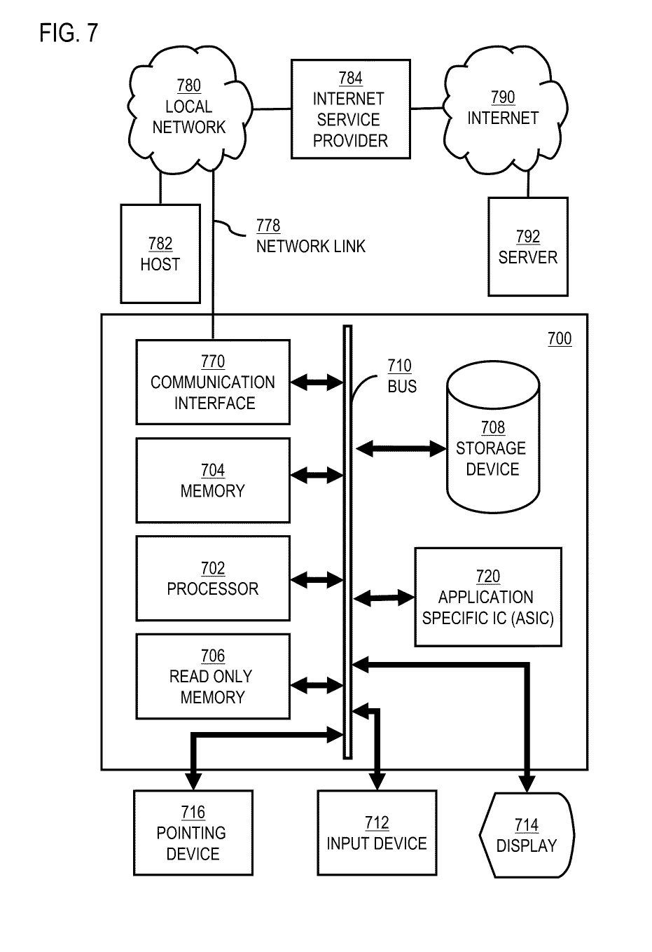

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to suggest information resources 111 based on context and preferences as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of enabling quick, efficient access to and storage of data within a database system comprising a plurality of data repository sites distributed across different physical locations.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to suggest information resources 111 based on context and preferences. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR) and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for suggesting information resources 111 based on context and preferences. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 707 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for suggesting information resources 111 based on context and preferences, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 717, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 717 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for suggesting information resources 111 based on context and preferences.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

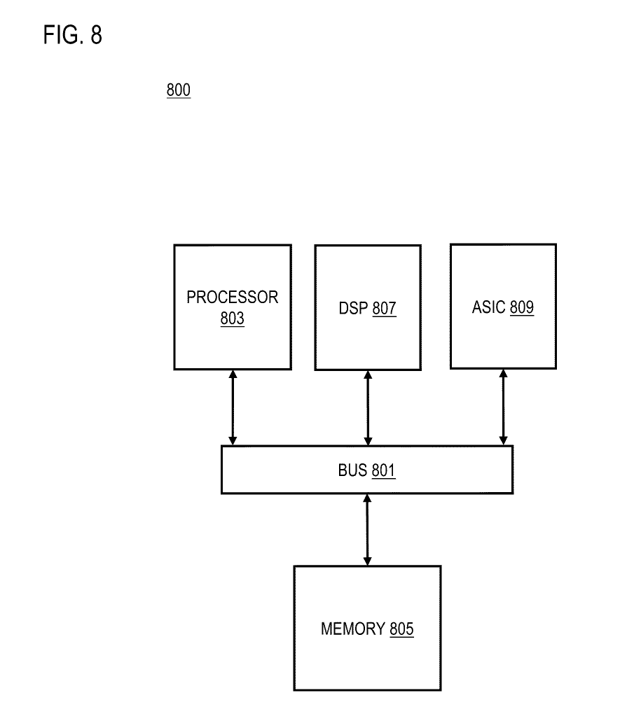

FIG. 8 illustrates a chip set 800 upon which an embodiment of the invention may be implemented. Chip set 800 is programmed to enable quick, efficient access to and storage of data within a database system comprising a plurality of data repository sites distributed across different physical locations as described herein and includes, for instance, the processor and memory components described with respect to FIG. 1 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of enabling quick, efficient access to and storage of data within a database system comprising a plurality of data repository sites distributed across different physical locations.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable quick, efficient access to and storage of data within a database system comprising a plurality of data repository sites distributed across different physical locations. The memory 805 also stores the data associated with or generated by the execution of the inventive steps.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request for data, wherein the request specifies a key value;
determining a bucket associated with one of a plurality of data repository sites of a virtual cache based on the key value, the data repository sites being in different physical locations, wherein the association between the bucket and the one data repository site is based on probability of serving the request; and
directing the request to the one data repository to retrieve the data.

2. A method according to claim 1, wherein the request is from a first client, the method further comprising:
receiving another request, from a second client, specifying the key value for concurrent processing with the request.

3. A method according to claim 1, wherein the request is from an interactive voice response (IVR) unit.

4. A method according to claim 3, wherein the data repository sites are geographically dispersed.

5. A method according to claim 1, further comprising:
determining whether the key value of the request is valid; and
generating an error message if the key value is not valid.

6. A method according to claim 1, wherein the one data repository site includes a content tracker configured to maintain a plurality of key values for the one data repository site and associated identifiers of respective client applications.

7. A method according to claim 6, wherein the one data repository site includes a plurality of servers and the content tracker is further configured to load balance among the servers.

8. A method according to claim 1, wherein the key value is assigned an expiry time for purging of the data.

9. An apparatus comprising:
a processor configured to receive a request for data, wherein the request specifies a key value,
wherein the processor is further configured to determine a bucket associated with one of a plurality of data repository sites of a virtual cache based on the key value, the data repository sites being in different physical locations,
wherein the association between the bucket and the one data repository site is based on probability of serving the request, and
wherein the processor is further configured to direct the request to the one data repository to retrieve the data.

10. An apparatus according to claim 9, wherein the request is from a first client and the processor is further configured to receive another request, from a second client, specifying the key value for concurrent processing with the request.

11. An apparatus according to claim 9, wherein the request is from an interactive voice response (IVR) unit.

12. An apparatus according to claim 11, wherein the data repository sites are geographically dispersed.

13. An apparatus according to claim 9, wherein the processor is further configured to determine whether the key value of the request is valid, and to generate an error message if the key value is not valid.

14. An apparatus according to claim 9, wherein the one data repository site includes a content tracker configured to maintain a plurality of key values for the one data repository site and associated identifiers of respective client applications.

15. An apparatus according to claim 14, wherein the one data repository site includes a plurality of servers and the content tracker is further configured to load balance among the servers.

16. An apparatus according to claim 9, wherein the key value is assigned an expiry time for purging of the data.

17. A virtual caching system comprising:
a site locator configured to process a request for data and to determine a bucket based on a key value within the request, the bucket being associated with one of a plurality of data repository sites based on the key value, the data repository sites being in different physical locations, wherein the association between the bucket and the one data repository site is based on probability of serving the request; and
a content tracker configured to maintain a plurality of key values for the one data repository site and associated identifiers of respective client applications that originate requests including the request.

18. A system according to claim 17, wherein the one data repository site includes a plurality of servers and the content tracker is further configured to load balance among the servers.

19. A system according to claim 17, wherein the request is from an interactive voice response (IVR) unit.

20. A system according to claim 17, wherein the site locator is further configured to determine whether the key value of the request is valid, and to generate an error message if the key value is not valid.
